(19) United States
(12) Patent Application Publication
(10) Pub. No.: US 2013/0262872 A1
(43) Pub. Date: Oct. 3, 2013

(54) ELECTRONIC APPARATUS, PERIPHERAL DEVICE, AND SYSTEM FOR ENCRYPTING AND DECRYPTING THE ELECTRONIC APPARATUS VIA THE PERIPHERAL DEVICE

(71) Applicants: HONG FU JIN PRECISION INDUSTRY (SHENZHEN) CO.,, Shenzhen (CN); HON HAI PRECISION INDUSTRY CO., LTD., New Taipei (TW)

(72) Inventors: ZHENG-CHAO XU, Shenzhen (CN); JIAN-HUNG HUNG, New Taipei (TW); MIN YANG, Shenzhen (CN); XIN-SHU WANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/688,454

(22) Filed: Nov. 29, 2012

(30) Foreign Application Priority Data
Apr. 2, 2012 (CN) 201210096190.2

(51) Int. Cl. G06F 21/31

(52) U.S. Cl. CPC G06F 21/31
USPC 713/183

(57) ABSTRACT

An electronic apparatus, a peripheral device, and a system for encrypting and decrypting the electronic apparatus via the peripheral device are provided. The electronic apparatus stores a password which a user sets in a ROM of the electronic apparatus and writes the password to the peripheral device. Only when the electronic apparatus is connected to the peripheral device, the electronic apparatus fetches a password from the peripheral device, and if the electronic apparatus determines that the fetches password is the same as the stored password in the electronic apparatus, the electronic apparatus performs a function of turning on or unlocking the electronic apparatus.

### BACKGROUND

1. Technical Field

The disclosure relates to encrypting and decrypting technology and, more particularly, to an electronic apparatus, a peripheral device, a system for encrypting and decrypting the electronic apparatus via the peripheral device.

2. Description of Related Art

A user often inputs a password to turn on or unlock an electronic device. However, the password is easily hacked or stolen by an illegal user, leading to data of legal users going missing.

Therefore, what is needed is an electronic apparatus to overcome the described shortcoming

### BRIEF DESCRIPTION OF THE DRAWINGS

FIG. 1 is a block diagram of a system for encrypting and decrypting an electronic apparatus via a peripheral device in accordance with an exemplary embodiment.

FIG. 2 is a block diagram of the peripheral device of the system of FIG. 1.

FIG. 3 is a circuit diagram of a minimum work unit of the peripheral device of FIG. 2.

FIG. 4 is a block diagram of an embedded controller of the electronic apparatus of the system of FIG. 1.

### DETAILED DESCRIPTION

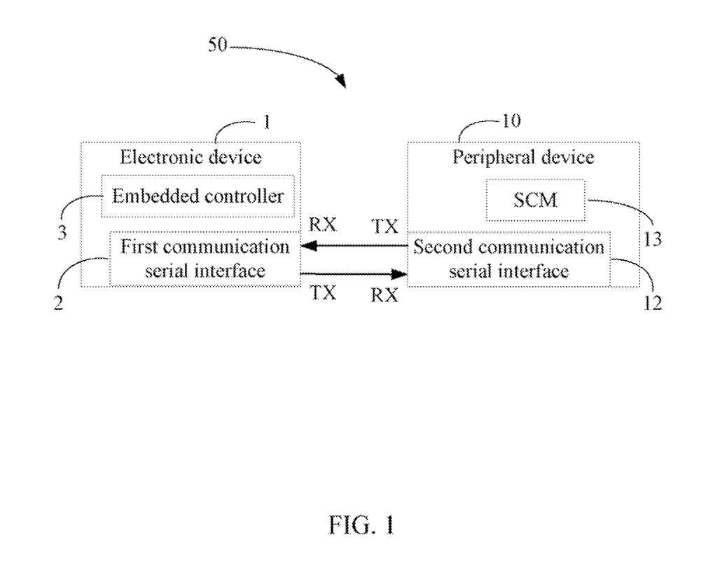

FIG. 1 is a block diagram of a system for encrypting and decrypting an electronic apparatus via a peripheral device in accordance with an exemplary embodiment. The system for encrypting and decrypting an electronic apparatus via a peripheral device (hereinafter “the system”) 50 includes an electronic apparatus 1 and a peripheral device 10. The electronic apparatus 1 must be decrypted for turning on or unlocking, such as computers, or mobile phones.

In the embodiment, the electronic apparatus 1 includes a first communication serial interface 2 and an embedded controller 3. The embedded controller 3 is utilized for controlling the electronic apparatus 1 to communicate with the peripheral device 10 and decrypting the electronic apparatus 1. The peripheral device 10 includes a second communication serial interface 12 and a single chip micyoco (SCM) 13. Both the first communication serial interface 2 and the second communication serial interface 12 have the same communication protocols and include TX and RX pins. The electronic apparatus 1 establishes a full-duplex communication with the peripheral device 10 via the first communication serial interface 2 and the second communication serial interface 12.

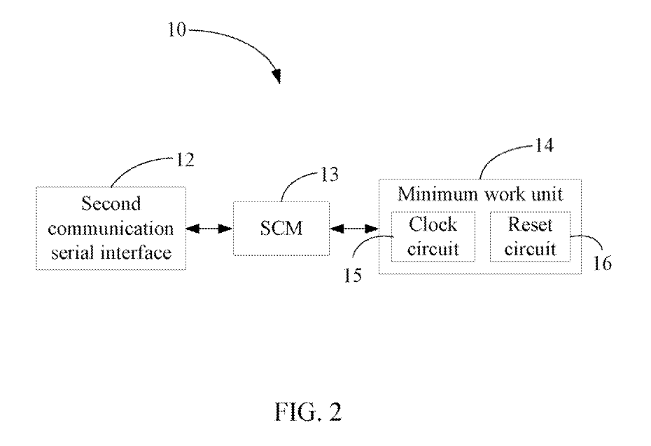

FIG. 2 is a block diagram of the peripheral device of the system of FIG. 1. The peripheral device 10 includes the second communication serial interface 12, the SCM 13, and a minimum work unit 14. The minimum work unit 14 represents necessary peripheral components which guarantee the SCM 13 to work normally. The minimum work unit 14 includes a clock circuit 15 and a reset circuit 16. The clock circuit 15 determines time precision of the SCM 13. The reset circuit 16 is utilized for decreasing an impedance for the ground of a reset pin of the peripheral device 10 on the premise that the SCM 13 has a reliable reset, therefore, highly increasing the anti jamming ability of the SCM 13. In the embodiment, the SCM 13 is an AT89S8252 chip.

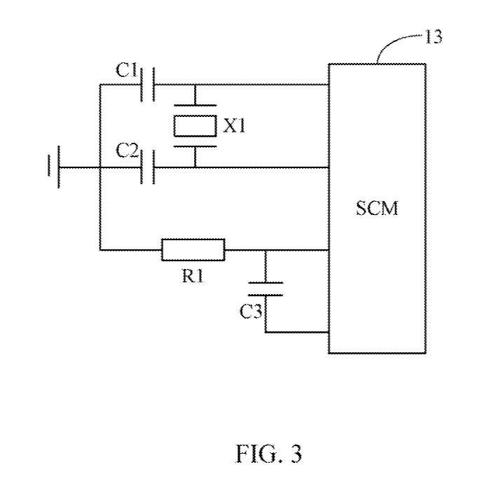

FIG. 3 is a circuit diagram of a minimum work unit of the peripheral device of FIG. 2. The clock circuit 15 is composed of a crystal oscillator X1 and two capacitances C1, C2. In the embodiment, the crystal oscillator X1 is about 11.0592M Hz, and both the two capacitances C1, C2 are about 33 pF, thereby guaranteeing a high precision for the SCM 13. The reset circuit 16 is composed of a capacitance C3 and a resistance R1. In the embodiment, the capacitance C3 is about 22 uF and the resistance R1 is about 1K ohm, thereby guaranteeing a good anti-jamming ability for the SCM 13.

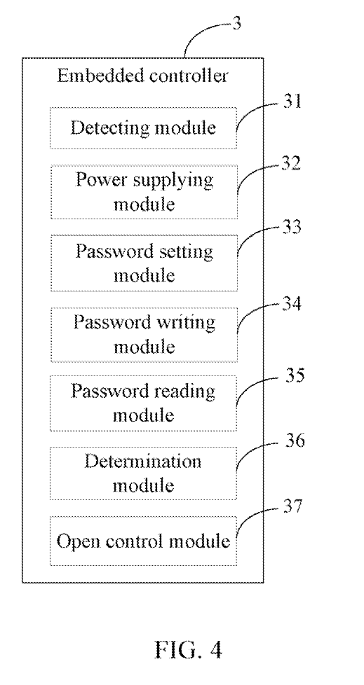

FIG. 4 is a block diagram of an embedded controller of an electronic apparatus of the system of FIG. 1. The embedded controller 3 includes a detecting module 31, a power supplying module 32, a password setting module 33, a password writing module 34, a password reading module 35, a determination module 36, and an open control module 37.

Before the peripheral device 10 is connected to the electronic apparatus 1, the electronic apparatus 1 is in a password setting state or a locked state and any user can not use the electronic apparatus 1 and control the electronic apparatus 1 to work. When the electronic apparatus 1 is first utilized in the password setting state, the electronic apparatus 1 needs to be set a password via the peripheral device 10 to turn on the electronic apparatus 1. The electronic apparatus 1 is in the locked state during use, such as a hibernation mode, and the electronic apparatus 1 can be unlocked via the peripheral device 10.

The detecting module 31 detects whether the electronic apparatus 1 is connected to the peripheral device 10, and generates a detecting signal when the electronic apparatus 1 is connected to the peripheral device 10. The power supplying module 32 supplies power for the peripheral device 10 via the first communication serial interface 2 in response to the detecting signal. In the embodiment, the power supplying module 32 supplies 3.3V power voltage for the connected peripheral device 10, the crystal oscillator of the connected peripheral device 10 starts to output frequency which is equal to a frequency of the embedded controller 3, thereby, achieving a full-duplex communication between the electronic apparatus 1 and the peripheral device 10. The first communication serial interface 2 and the second communication serial interface 12 respectively includes at least four pins, e.g., the TX pin, the RX pin, a voltage pin, and a ground pin.

When the electronic apparatus 1 is connected to the peripheral device 10, the password setting module 33 generates a password setting interface, sets the password on the password setting interface in response to user inputs, and stores the set password in a read-only memory (ROM) of the embedded controller 3. When the password setting module 33 finishes setting the password, for example, when the password is set, an “ok” button on the password setting interface is touched in response to user inputs, the password writing module 34 writes the set password to an electrically erasable programmable read-only memory (EEPROM) of the SCM 13 of the peripheral device 10. For example, the password writing module 34 controls the TX pin of the first communication serial interface 2 to transmit password data to the peripheral device 10, the RX pin of the second communication serial interface 12 of the peripheral device 10 receives the password data, the SCM 13 processes the password data to obtain the set password, and the EEPROM of the SCM 13 stores the set password.

When the electronic apparatus 1 is locked, the electronic apparatus 1 is connected to the peripheral device 10, the power supplying module 32 supplies power for the peripheral device 10, the password reading module 35 sends a password acquiring signal to the peripheral device 10 and reads a password from the peripheral device 10. For example, the TX pin of the second communication serial interface 12 of the peripheral device 10 reads the password in response to the password acquiring signal to the electronic apparatus 1 and the password writing module 34 receives the password via the RX pin of the first communication serial interface 2 from the peripheral device 10.

The determination module 36 determines whether the password read by the password reading module 35 is the same as the password stored in the ROM of the embedded controller 3. When the password read by the password reading module 35 is the same as the password stored in the ROM of the embedded controller 3, the open controlling module 37 turns on or unlocks the electronic apparatus 1, therefore, the user can operate the electronic apparatus 1 and the electronic apparatus 1 enters a work state. When the password read by the password reading module 35 is different from the password stored in the ROM of the embedded controller 3, the open controlling module 37 controls the electronic apparatus 1 to remain in the locked state, therefore, the user can not operate the electronic apparatus 1 and acquire any data of the electronic apparatus 1.

If the user wants to change the password of the electronic apparatus 1, the electronic apparatus 1 must be connected to the peripheral device 10, the password setting module 33 sets a new password on the password setting interface in response to user inputs and stores the new password, and the password writing module 34 writes the new password to the SCM 13.

Therefore, the electronic apparatus 1 writes the password to the peripheral device 10 and stores the password in the ROM of the embedded controller 3. When the user wants to unlock the electronic apparatus 1, the electronic apparatus 1 is connected to the peripheral device 10 and establishes a full-duplex communication with the peripheral device 10 and the electronic apparatus 1 reads a password from the peripheral device 10 and validates the password to turn on or unlock the electronic apparatus 1. The user of the electronic apparatus 1 does not need to remember the password, if an illegal user does not know the password is stored in the peripheral device 10, the electronic apparatus 1 is not unlocked, thereby guaranteeing that the data in electronic apparatus 1 is safe.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A system for encrypting and decrypting an electronic apparatus via a peripheral device, the system comprising:
the electronic apparatus comprising a first communication serial interface; and
the peripheral device comprising a second communication serial interface;
wherein both the electronic apparatus and the peripheral device respectively store a password, when the electronic apparatus is in a locked state, the electronic apparatus is configured to detect whether the first communication serial interface is connected to the second communication serial interface of the peripheral device, and when the first communication serial interface is connected to the second communication serial interface, the electronic apparatus is configured to supply power for the peripheral device and establish a full-duplex communication with the peripheral device; and
the electronic apparatus is configured to read the password from the peripheral device and determine whether the password from the peripheral device is the same as the password in the electronic apparatus, and when the password from the peripheral device is the same as the password in the electronic apparatus, the electronic apparatus is turned on or unlocked.

2. The system as recited in claim 1, wherein when the read password from the peripheral device is different from the stored password in the electronic apparatus, the electronic apparatus remains in the locked state.

3. The system as recited in claim 1, wherein when the electronic apparatus is connected to the peripheral device, the electronic apparatus sets the password in response to user inputs, stores the password, and writes the password to the peripheral device.

4. The system as recited in claim 1, wherein the peripheral device comprises a single chip micyoco, a clock circuit, and a reset circuit, the single chip micyoco is configured to control the clock circuit and the reset circuit to work, the clock circuit is composed of a crystal oscillator X1 and two capacitances C1, C2, the crystal oscillator X1 is about 11.0592M Hz, both the two capacitances C1, C2 are about 33 pF; the reset circuit is composed of a capacitance C3 and a resistance R1, the capacitance C3 is about 22 uF and the resistance R1 is about 1K ohm.

5. The system as recited in claim 4, wherein the single chip micyoco is an AT89S8252 chip.

6. An electronic apparatus encrypted and decrypted via a peripheral device, the electronic apparatus comprising:
a communication serial interface; and
an embedded controller stored a password, the embedded controller comprising:
a detecting module configured to detect whether the communication serial interface is connected to the peripheral device when the electronic apparatus is in a locked state, and generate a detecting signal when the communication serial interface is connected to the peripheral device;
a power supplying module configured to supply power for the peripheral device to establish a full-duplex communication with the peripheral device based on the detecting signal;
a password reading module configured to read a password from the peripheral device when the electronic apparatus establishes a full-duplex communication with the peripheral device;
a determination module configured to determine whether the password from the peripheral device is the same as the password in the electronic apparatus; and
an open controlling module configured to turn on or unlock the electronic apparatus when the password from the peripheral device is the same as the password in the electronic apparatus.

7. The electronic apparatus as recited in claim 6, wherein when the password from the peripheral device is different from the password in the electronic apparatus, the open controlling module remains in the locked state.

8. The electronic apparatus as recited in claim 6, further comprising:
a password setting module configured to generate a password setting interface and set the password on the password setting interface in response to user inputs, and store the password in the embedded controller; and
a password writing module configured to write the password to the peripheral device via the communication serial interface after the password setting module sets the password.

9. The electronic apparatus as recited in claim 6, wherein the communication serial interface comprises a TX pin, a RX pin, a voltage pin, and a ground pin.

10. A peripheral device for encrypting and decrypting an electronic apparatus, the peripheral device comprising:
a communication serial interface; and
a single chip micyoco;
wherein the single chip micyoco stores a password, when the electronic apparatus is in a locked state, the peripheral device is connected to the electronic apparatus via the communication serial interface, receives power voltage provided by the electronic apparatus, and achieves a full-duplex communication with the electronic apparatus; and when the password stored in the single chip micyoco is the same as a stored password in the electronic apparatus, the electronic apparatus is turned on or unlocked.

11. The peripheral device as recited in claim 10, wherein the communication serial interface comprises a TX pin, a RX pin, a voltage pin, and a ground pin.

12. The peripheral device as recited in claim 10, wherein the peripheral device further comprises a clock circuit and a reset circuit, the clock circuit is composed of a crystal oscillator X1 and two capacitances C1, C2, the crystal oscillator X1 is about 11.0592M Hz, both the two capacitances C1, C2 are about 33 pF; the reset circuit is composed of a capacitance C3 and a resistance R1, the capacitance C3 is about 22 uF and the resistance R1 is about 1K ohm.

13. The peripheral device as recited in claim 10, wherein the single chip micyoco is an AT89S8252 chip.
